(19) United States
(12) Patent Application Publication
(10) Pub. No.: US 2025/0309465 A1
(43) Pub. Date: Oct. 2, 2025

(54) PRESSURE EQUALIZATION DEVICE FOR A BATTERY HOUSING

(71) Applicant: Illinois Tool Works Inc., Glenview, IL (US)

(72) Inventors: Fulvio Pacifico YON, Glenview, IL (US); Ilaria Giacomelli, Glevniew, IL (US)

(21) Appl. No.: 18/863,902

(22) PCT Filed: May 5, 2023
(86) PCT No.: PCT/IB2023/000265

§ 371 Date: Nov. 7, 2024

(30) Foreign Application Priority Data
May 9, 2022 (EP) 22172381.0
May 11, 2022 (EP) 22172803.3
May 24, 2022 (EP) 22175084.7
Feb. 22, 2023 (EP) 23157922.8
Mar. 17, 2023 (EP) 23162552.6

(51) Int. Cl. H01M 50/30; H01M 50/325

(52) U.S. Cl. CPC H01M 50/394; H01M 50/325

(57) ABSTRACT

The invention relates to a pressure equalizing device (1, 201, 301, 401) for a battery case. The device comprises a cage (2, 202, 302, 402) describing a fluid passage (23, 223, 323, 423), a lid (4, 204, 304, 404) mounted on the cage and a membrane (34, 234, 334, 434) covering the fluid passage to equalize the pressure inside the housing with the ambient pressure outside the housing. The lid is movable during use between an open configuration in which air can escape, and a closed configuration in which the housing is sealed.

### TECHNICAL FIELD OF THE INVENTION

The invention relates to the field of pressure equalizing devices, making it possible to compensate for the variation in pressure inside a battery and to systematically release the pressure in the event of overpressure (for example, by means of a degassing device).

### TECHNICAL BACKGROUND

The use of a pressure compensation element for accumulators is known from patent EP3385584, filed by Freudenberg. More precisely, this element combines the function of pressure compensation in normal operation but also that of reducing the overpressure during an emergency degassing.

### SUMMARY OF THE INVENTION

The invention concerns a pressure equalizing device for a battery case.

The device may include a cage. The cage can describe a fluid passage. The device can advantageously comprise a lid, which can be mounted on the cage. The lid can be movable, for example between an open configuration, in which air can escape out of the housing during use, and a closed configuration in which the housing is sealed.

The invention also concerns a pressure equalizing device for a housing, the device comprising a cage describing a fluid passage and a lid mounted on the cage, characterized by the fact that the lid is movable during use between an open configuration, characterized by the fact air can escape, and a closed configuration in which the housing is sealed.

The device may include a membrane which may cover the fluid passage, for example to equalize the pressure inside the housing with the ambient pressure outside the housing.

The invention also concerns a pressure equalizing device for a housing, with the device comprising a cage describing a fluid passage, a lid mounted on the cage and a membrane covering the fluid passage to equalize the pressure inside the housing with the ambient pressure outside the housing, in which the lid is movable during use between an open configuration, in which the air can escape, and a closed configuration, in which the housing is sealed.

The lid can be rotated between the open and closed configurations or positions.

At least one of either the lid and the cage may include a formation, for example a sloped, helical or screw-shaped formation. The formation may cooperate with a formation on the other of the lid and the cage to cause the lid to move relative to the cage when rotated between the open and closed configurations or positions.

The lid can be screwed between the open and closed configurations or positions. The device may comprise sealing means on one or both of the lid and/or of the cage, for example which seal the housing when the lid is in the closed configuration or position.

The lid may include one or more windows. The cage may include one or more windows. The (or, each) window of the lid can be aligned with the or a corresponding window of the cage, for example when the lid is in the open position. The (or, each) window of the lid can be misaligned or offset with respect to the corresponding window or windows of the cage, for example when the lid is in the closed position. The device may include a seal, for example a window seal, which may be configured to seal the fluid exchange between the windows, for example when the lid is in the closed position.

The device may comprise a valve element, for example a flexible umbrella. The valve element can cover the fluid passage. The valve element may include an orifice, for example through its thickness. The valve element may comprise a membrane or the membrane, which may be attached to the valve element and/or may cover the orifice.

The valve element membrane may be configured to equalize during use the pressure inside the battery case with the ambient pressure outside the battery case. The valve element can be configured to move or deform in a reversible way—for example, at a predetermined pressure differential between the inside and the outside of the battery case, as to prevent overpressure forming inside the battery case.

Thus, the invention provides a pressure equalizing device that is both compact and allows a high degassing flow.

Also, the membrane may be gas permeable and liquid impermeable, for example to allow air to pass through it in order to equalize the pressure inside the battery case with the ambient pressure outside the battery case. The membrane can be integrated or molded over the valve element. Furthermore, all orifices can be covered with a single membrane, or each orifice can be covered with a separate membrane.

Alternatively, the membrane can be configured to move or deform in a reversible way, for example to equalize the pressure inside the battery case with the ambient pressure outside the battery case.

The valve element may include a disc. The valve element or disc may include a canopy. At least part of the orifice may be next to the disc or the canopy. At least a portion of the orifice may at least partially surround the disc or the canopy. Alternatively, the orifice may extend through the disc or the canopy. The disc or canopy can be rigid or flexible. The disc or canopy can be flat or curved. The disc or canopy can be compressed or pushed to a closed position, for example in which it covers the fluid passage.

An advantage of the invention is the fact that the cage can comprise a central support. The fluid passage may consist of one of two or more fluid passage around the central support. The valve element may include a flexible umbrella valve element. The valve element may include a rod, which can be connected to the central support.

Furthermore, the disc can be pushed towards a closed position by a pressure means, such as a spring, for example to cover the fluid passage. The disc or the cage may comprise a seal or a sealing means, for example a seal or a peripheral sealing means. The seal or the sealing means may extend around the periphery of the fluid passage(s) or of the disc. The seal or the sealing means can be configured to seal and/or to create a seal between the disc and the cage, for example when the disc is in the closed position.

The disc or canopy can be configured to move or deform in a reversible way at a predetermined pressure differential between the inside and the outside of the battery case to prevent overpressure forming inside the battery case.

The canopy may extend radially from the rod, for example to cover the fluid passage.

An advantage of the invention is the fact that the orifice is one of two or more holes through the disc or canopy. Each of the holes may be covered by the membrane or a respective membrane.

Furthermore, the cage may include a lip and/or a seal. The gasket can be spaced from the lip. The seal and the lip can be configured to capture during use a wall of the battery case between them, for example to seal the cage in a orifice of the battery case.

Also, the cage may include a bayonet connection. The bayonet connection can have two or more flanges, each of which can describe part of a lip.

The cage may include a valve seat. The valve element or the disc or the canopy of the valve element can engage, for example sealing against the valve seat when the disc or the canopy covers the fluid passage. The cage may include a sealing part. The sealing piece may comprise the gasket and/or the valve seat. The seal can be connected to the valve seat, for example by one or more bridging columns.

The disc or the canopy may include one or more sealing lips, which may be configured to engage the valve seat. The (or. at least) one sealing lip may comprise a pair of sealing lips, which may be spaced apart, for example the at least one sealing lip may comprise a pair of spaced apart sealing lips.

The seal and/or the valve seat and/or the sealing part can be formed integrally with the cage, for example by an molding process. The seal can be located on a first side, for example a bottom side, of the cage. The valve seat may be located on a second side, for example a top side, of the cage, which may be opposite the first side. The bridging columns can extend through the cage.

The pressure means which pushes the disc towards the closed position can be held between the disc and the lid. The disc and/or the lid may include a connector, for example to connect to one end of the spring. The disc may include a projection, which may be received by one end of the pressure means. The lid may comprise a housing or a sleeve, for example in which the other of the ends of the pressure means may be received. The lid housing or socket may surround at least a portion of the disc projection. Furthermore, the lid may comprise a projection, which may be received by one end of the pressure means, and/or the disc may comprise a housing or a socket, for example in which the other of the ends of the pressure means may be received and/or the disc housing or sleeve may surround at least a portion of the lid projection.

For the avoidance of doubt, all the features described herein also apply to any aspect of the invention.

As part of this application, it is expressly provided that the various aspects, embodiments, embodiments of the invention and alternatives disclosed in the preceding paragraphs, in the claims and/or in the following description and drawings, and in particular the individual features thereof, may be taken separately or in any combination. In other words, all embodiments and/or features of any embodiment may be combined in any way, unless these features are incompatible.

For the avoidance of doubt, the terms “can”, “and/or”, “for example”, and any other similar term used herein must be interpreted as not limiting, such that any feature described herein is not necessarily required to be present. Indeed, any combination of optional features is expressly foreseen without departing from the scope of the invention, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE FIGURES

Other features and advantages of the invention will become apparent from the following detailed description, which will be understood in reference to the appended drawings, in which:

FIG. 1 illustrates a pressure equalizing device for a battery case according to an embodiment of the invention;

FIG. 2 illustrates the device of FIG. 1 without its top lid;

FIG. 3 illustrates a side view of the device of FIG. 1 from below, showing the engagement between the lid and the tubular wall;

FIG. 4 illustrates a perspective view of the device of FIG. 1 from below;

FIG. 5 illustrates a sectional view of the device of FIGS. 1 to 4; and

FIG. 6 illustrates a sectional view of a valve element for a pressure equalizing device for a battery case according to another embodiment of the invention;

FIG. 7 illustrates a pressure equalizing device for a housing according to another embodiment of the invention;

FIG. 8 illustrates a sectional view of the device of FIG. 7;

FIGS. 9 and 10 illustrate a pressure equalizing device according to another embodiment of the invention; and

FIGS. 11 and 12 illustrate a pressure equalizing device according to another embodiment of the invention.

### DETAILED DESCRIPTION OF THE INVENTION

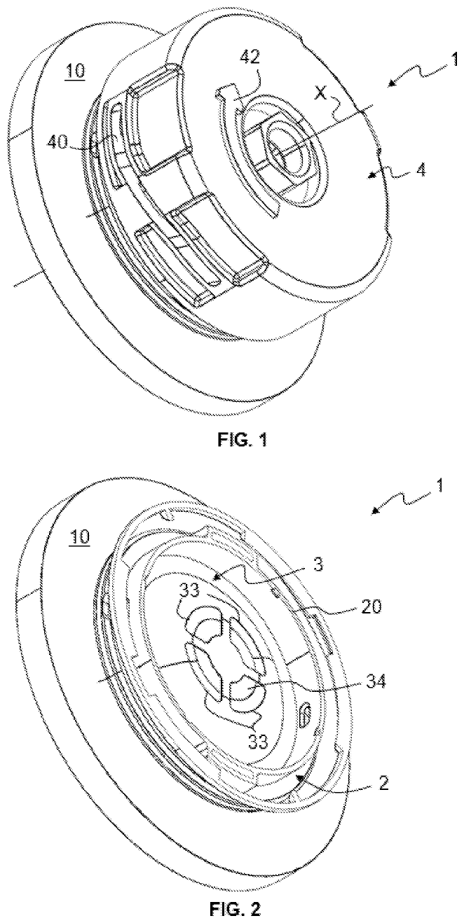

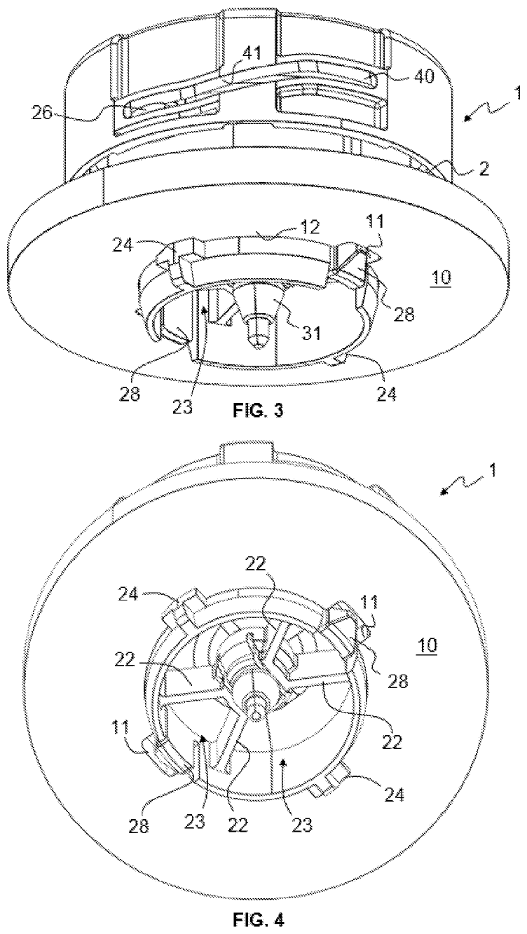

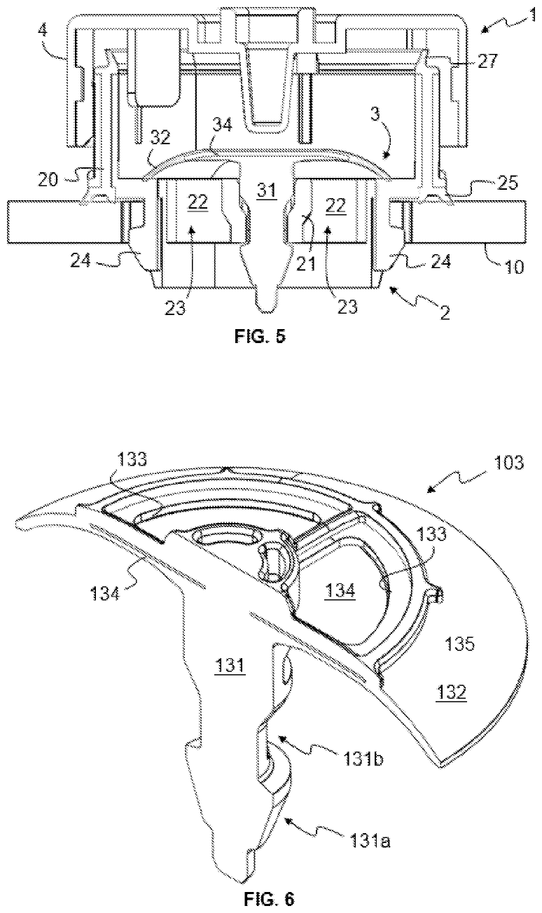

Different aspects of different embodiments of the invention are described in more detail below, in reference to FIGS. 1 to 12.

FIGS. 1 to 5 show a pressure equalizing device 1 according to a first embodiment of the invention, which is mounted on a battery case wall 10 (only part of which is shown). The device 1 comprises a primary axis X, a cage 2, a valve element 3 which is mounted in the cage 2 and a lid 4 which is mounted on the cage 2. The battery case wall 10 includes a orifice 11 inside which the device 1 is mounted.

The cage 2 comprises a tubular wall 20, a central support 21 connected to the tubular wall 20 by four radial walls 22. The fluid passages 23 are described between the radial walls 22, which provide fluid passage between the interior of battery case wall 10 and the interior of cage 2.

Two radial flanges 24 project outward from the lower end of tubular wall 20. The radial flanges 24 cooperate with two radials tabs 12 of battery case wall 10 to provide a bayonet connection to fix device 1 in orifice 11 of battery case wall 10. A gasket 25 depends from tubular wall 20 and the radial flanges 24 together form a lip, so that the wall of battery case 10 is held between the lip and gasket 25.

Cage 2 is therefore assembled in orifice 11, whereas this orifice is made on the top of the battery, with a ½ turn fixing system. Such a solution makes it possible to free up the available space of orifice 11 as much as possible and thus optimize the flow of fluid through the fluid passage 23 of cage 2. Therefore, such a profile in ½ turn configuration to be fixed on battery case wall 10 makes it possible to obtain an optimum flow to evacuate the pressure inside the battery by freeing orifice 11 of the battery case as much as possible.

Cover 4 surrounds tubular wall 20 of cage 2 and covers its open end. Cover 4 includes slots 40 which receive projections 26 on tubular wall 20 to provide a connection between lid 4 and tubular wall 20. More specifically, tubular wall 20 includes a seal 27 around its open end and each of slots 40 of lid 4 includes a helical segment 41. These helical segments 41 cooperate with projection 26 of tubular wall 20 to bring seal 27 closer and further from lid 4 during rotation.

Accordingly, rotation of lid 4 in the direction illustrated by arrow 42, shown in FIG. 1, pulls lid 4 farther over tubular wall 20, thereby creating a tight connection between them. This configuration can be advantageous when the battery case needs to be pressure tested. Specifically, the open position is for venting/degassing (normal operation) and the closed position is for performing the 100% air leakage test of the battery case.

In this embodiment of the invention, the bayonet fitting only includes two flanges 24, but it also includes a pair of spring loaded locking stops 28. Tabs 12 protruding into orifice 11 extend over most of the periphery so that locking stops 28 snap into place between tabs 12, thereby preventing rotation of cage 2 when lid 4 is rotated relative to it.

Valve element 3 comprises a rod 31 connected to central support 21 and a canopy 32 extending radially from rod 31, which covers the fluid passage 23. The valve element 3 is therefore an umbrella valve element 3. Canopy 32 preferably has a domed shape, and is made of a flexible material in order to increase the closing tension. According to a variant of the invention, canopy 32 has a flat shape. Umbrella valve element 3 can be made of shock-absorbing material with a high-strength polytetrafluoroethylene (PTFE) membrane.

Canopy 32 includes four holes 33 passing through its thickness, which are covered with a membrane 34. Membrane 34 is gas permeable and liquid impermeable to allow air to pass through it to equalize the pressure inside battery case 10 with the ambient pressure outside battery case 10.

Preferably, membrane 34 is molded inflexible umbrella valve element 3. Alternatively, holes 33 can be covered by a respective membrane 34. In some embodiments of the invention, membrane 34 may be air impermeable and may be designed to flex enough to allow some pressure equalizing.

During use, the air inside the battery case is equalized by the transmission of air through membrane 34. If the pressure inside the battery case exceeds a predetermined threshold, canopy 32 of the umbrella valve element 3 is forced to flex away from the fluid passage 23. Thus, high pressure air can be expelled from the battery case to prevent overpressure.

In operation, the present invention thus makes it possible to perform two pressure equalizing functions. A first function, called degassing function, in which the canopy 32 of valve element 3 is deformed by the high pressure coming from the battery, which is the housing in a thermal runaway situation (emergency) and in which it is necessary to degas it over a very short period of time; otherwise, the battery will explode.

A second function is called the ventilation function, in which membrane 34 acts as a filter which compensates for variations in air pressure to maintain the pressure inside the battery equal to the pressure outside. Membrane 34 can be a technical fabric impermeable (PTFE) to liquids, but not to air. Therefore, the membrane is adapted to allow air to pass for reduced flow rates, thus enabling the ventilation function.

Thus, valve element 3 of the valve type makes it possible to compensate for the variation in pressure inside the battery and to systematically release the pressure (emergency degassing valve). In other words, valve element 3 can both vent to balance internal pressure equivalent to external pressure, degas for high internal pressure (emergency) in a short time, and be waterproof to high water pressure coming from the outside.

Referring now to FIG. 6, we see a valve element 103 according to a second embodiment of the invention, which is similar to the first embodiment of the invention in that similar features are marked with like numbers incremented by 100. Valve element 103 according to this embodiment of the invention differs from that of the first embodiment of the invention in that canopy 132 incorporates reinforcing ribs 135 surrounding holes 133.

As shown more clearly in FIGS. 6, rod 131 includes a tapered end 131a and a tapered portion 131b. Valve member 103 is mounted on cage 2 by inserting tapered end 131a of rod 131 into center support 21 and forcing rod 131 into center support 21 until tapered end 131a projects from the other end and that central support 21 is held in narrowed part 131b. Other arrangements are also possible.

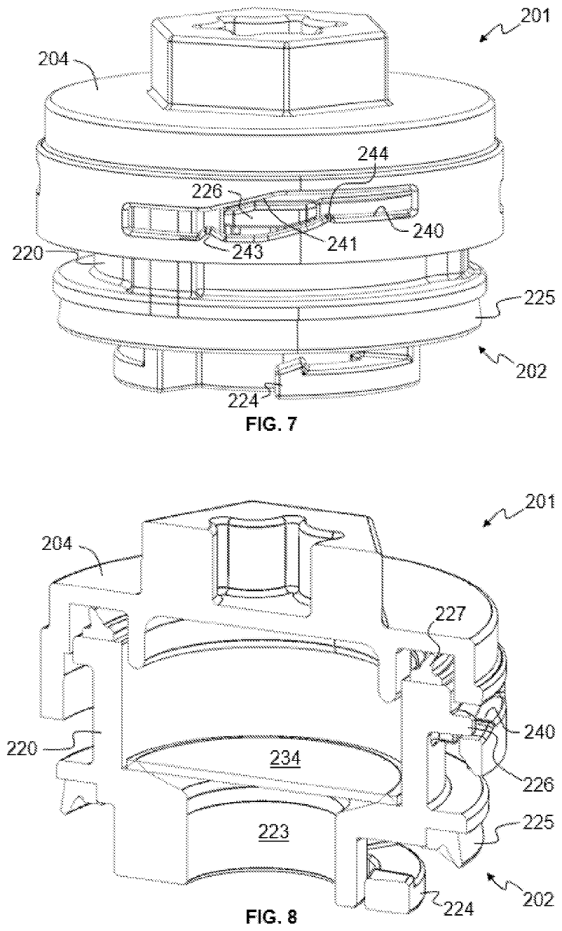

Referring now to FIGS. 7 and 8, a pressure equalizing device 201 according to another embodiment of the invention is shown which is similar to the first embodiment of the invention in that similar features are marked with similar numbers incremented by 200. Pressure equalizing device 201 according to this embodiment of the invention differs from that of the first embodiment of the invention in that valve element 3 is omitted and replaced simply by a membrane 234.

Thus, in this embodiment of the invention, only one pressure equalizing function is performed, namely the ventilation function. More specifically, membrane 234 acts as a filter which compensates for variations in air pressure to maintain the pressure inside the battery equal to the pressure outside. As in the previous embodiments of the invention, membrane 234 is preferably an engineered fabric (PTFE) impermeable to liquids but not to air, but in other embodiments of the invention it may be simply deformable to equalize slight variations in pressure. However, unlike the previous embodiments of the invention, the equalization device 201 according to this embodiment of the invention does not include the degassing function.

Furthermore, slots 240 include projections 243, 244 at each end of helical segment 241. Thus, the projections 226 on tubular wall 220 engage when lid 204 is rotated to the closed position and to the open position. Projections 243, 244 of slots 240 inhibit, but do not prevent, rotation of lid 204 out of the closed and open positions.

However, projection 243 which retains lid 204 in the open position exceeds projection 244 which retains lid 204 in the closed position. Thus, rotation of lid 204 out of the open position requires greater torque than rotation out of the closed position.

As in the previous case, in the closed position the lid is sealed against seal 227 around the open end of tubular wall 220. This prevents any ventilation, for example during a pressure test.

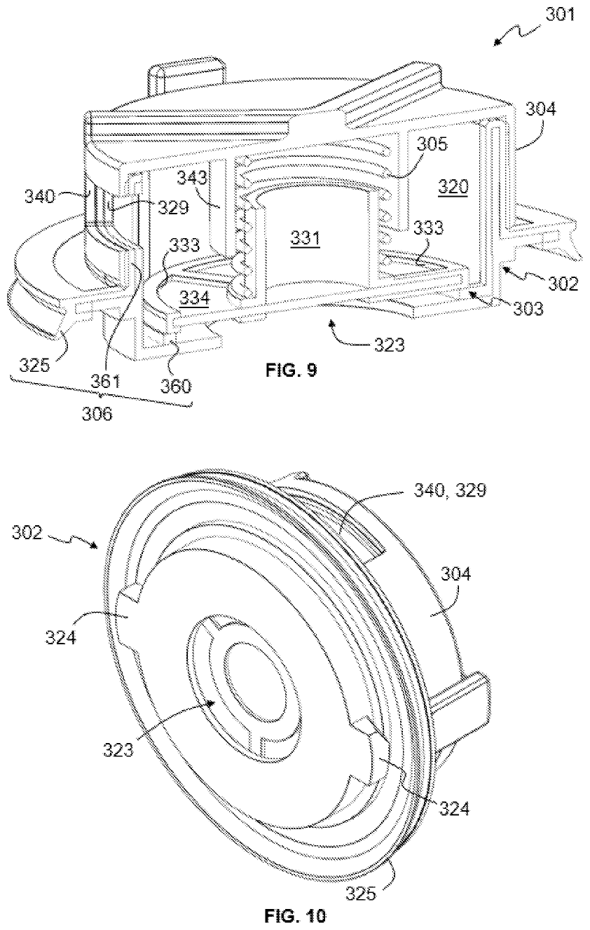

Referring now to FIGS. 9 and 10, they show a pressure equalizing device 301 according to another embodiment of the invention, which is similar to the first embodiment of the invention in that similar features are marked with similar numerals incremented by 300. Pressure equalizing device 301 according to this embodiment of the invention differs from that of the first embodiment of the invention in that the umbrella valve element 3 is replaced by a disc 303 and the rotation of lid 304 selectively aligns windows 340, 329 through lid 304 and tubular wall 320.

Disc 303 has holes 333 in its thickness, which are covered by a molded membrane 334, and a tubular wall 331 projects from the center of disc 303. Lid 304 also includes a dependent tubular wall 343, which is aligned with tubular wall 331 of the disc 303 and surrounds it. Device 301 comprises a spring 305, a first end of which surrounds tubular wall 331 of disc 303 and a second end of which is received in tubular wall 343 of lid 304. Spring 305 pushes disc 303 to a closed position in which it covers fluid passage 323.

In this embodiment of the invention, a sealant 306 is molded over areas of cage 302. Specifically, sealant 306 includes gasket 325 which depends from tubular wall 320 as well as disc seal 360 surrounding fluid passage 323, which engages disc 303 when in closed position. Sealant 306 also includes window gasket 361 surrounding window 329 through cage 302.

Therefore, fluid can pass from the battery case through fluid passage 323, through membrane 334 (or between cage 302 and disc 303 when moved), and exit through windows 329, 340 when cover 304 is in the open position (shown in FIG. 16). However, when lid 304 is rotated so that windows 329, 340 are no longer aligned, window seal 361 seals fluid passage during a 100% air leakage test from the battery case.

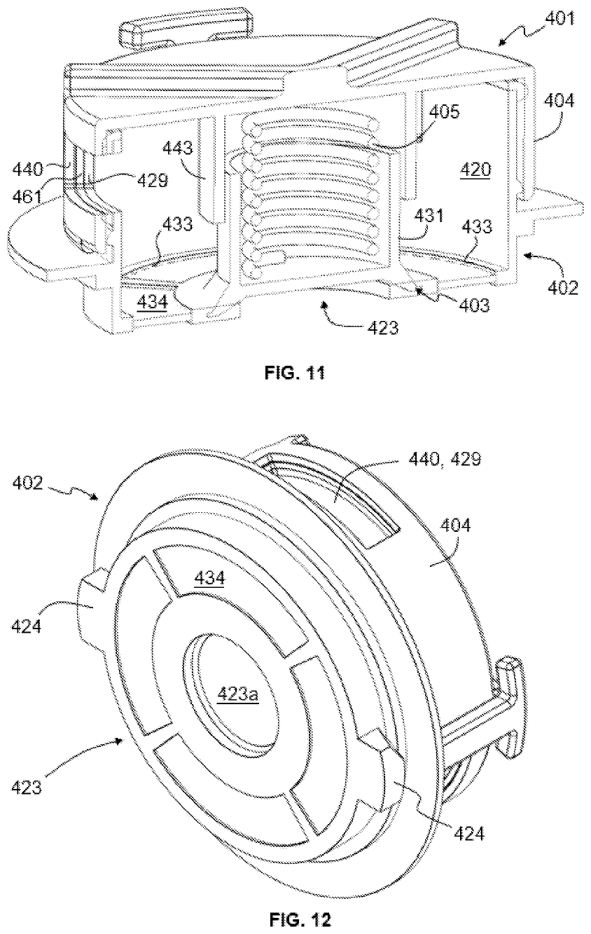

Referring now to FIGS. 11 and 12, there is a pressure equalizing device 401 shown according to another embodiment of the invention, which is similar to the previous embodiment of the invention in that similar features are marked with similar numerals incremented by 100. Pressure equalizing device 401 according to this embodiment of the invention differs from that in the previous embodiment of the invention in that holes 433 pass through a base of cage 402, while the diameter of disc 403 corresponds to the diameter of tubular wall 433, and disc 403 has a peripheral seal 436 which seals into the base of cage 402. Thus, in the event of an overpressure situation, disc 403 is moved to reveal a central orifice 423a through the base of cage 402.

A person skilled in the art will be aware that several variants of the aforementioned embodiments are conceivable without departing from the scope of the invention.

Throughout the description and claims of this specification, the words “comprise” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification should be understood to include the plural as well as the singular, unless the context requires otherwise.

Any features, integers, characteristics, compounds or groups described in connection with a particular aspect, embodiment or embodiment of the invention are to be understood as being applicable to any other aspect, embodiment or embodiment of the invention described herein, unless inconsistent therewith. All of the features disclosed in this specification (including the claims, abstract and accompanying drawings), and/or all of the steps of a method or of a process thus disclosed, may be combined in any combination other than combinations in which at least some of such features and/or steps are mutually exclusive. The invention is not limited to the details of all of the preceding embodiments. The invention extends to any new feature or any new combination of the features disclosed in this specification (including the claims, abstract and accompanying drawings), or to any new feature or any new combination of the steps of any method or process thus disclosed.

The reader's attention is drawn to all papers and documents that are filed concurrently or prior to this specification in connection with this application and that are open for public inspection with this specification, and the content of all such papers and documents is incorporated herein by reference.

1. A pressure equalizing device for a battery case, the pressure equalizing device comprising:
a cage describing a fluid passage;
a lid mounted on the cage; and
a membrane covering the fluid passage to equalize the pressure inside a housing of the battery case with ambient pressure outside the housing;
wherein the lid is movable, in use, between an open configuration, in which air can escape, and a closed configuration, in which the housing is sealed.

2. The pressure equalizing device according to claim 1, wherein the membrane is gas permeable and liquid impermeable to allow air to pass through it to equalize the pressure inside the battery case with the ambient pressure. outside the battery case.

3. The pressure equalizing device according to claim 1, wherein the lid can be rotated between the open and closed configurations.

4. The pressure equalizing device according to claim 3, wherein at least one of the lid and of the cage comprises an inclined, helical or screw-shaped formation.

5. The pressure equalizing device according to claim 4, wherein the inclined, helical or screw-shaped formation cooperates with a formation on the other of the lid and of the cage to cause the lid to translate relative to the cage when rotated between the open and closed configurations.

6. The pressure equalizing device according to claim 1, wherein the lid screws on between the open and closed configurations.

7. The pressure equalizing device according to claim 1, wherein the device comprises sealing means on one or both of the lid or and/e of the cage which seal the housing when the lid is in the closed configuration.

8. The pressure equalizing device according to claim 1, wherein the lid and the cage each comprise a window; the window in the lid is aligned with the window in the cage when the lid is in the open position and the window in the lid is unaligned or offset from the window in the cage when the lid is in the closed position.

9. The pressure equalizing device according to claim 8, wherein the device comprises a gasket that is configured to seal fluid communication between the windows when the lid is in the closed position.

10. The pressure equalizing device according to claim 1, wherein the device comprises:
a valve element covering the fluid passage; the valve element comprises an orifice through its thickness and the membrane is attached to the valve element and covers the orifice,
wherein the membrane is configured to equalize, in use, the pressure inside the battery case with the ambient pressure outside the battery case
while the valve element is configured to move or to deform in a reversible way at a predetermined pressure differential between the inside and the outside of the battery case to prevent overpressure inside the battery case.

11. The pressure equalizing device according to claim 10, wherein the cage comprises a central support and the fluid passage is one of two or more fluid passages around the central support, wherein the valve element comprises a rod connected to the central support and a canopy extending radially from the rod to cover the fluid passage.

12. The pressure equalizing device according to claim 11, wherein the orifice is one of two or more holes through the canopy, each of which is covered by the membrane or a respective membrane.

13. The pressure equalizing device according to claim 11, wherein the cage comprises a lip and a gasket spaced from the lip which are configured to capture, in use, a wall of the battery case between them to seal the cage in an orifice in the battery case.

14. The pressure equalizing device according to claim 13, wherein the seal is connected to a valve seat by bridging columns that extend through the cage.

15. The pressure equalizing device according to claim 13, wherein the cage comprises a bayonet connection with two or more flanges each describing a portion of the lip of the cage.
